(19) United States
(12) Patent Application Publication
(10) Pub. No.: US 2023/0258600 A1
(43) Pub. Date: Aug. 17, 2023

(54) APPARATUS AND METHOD FOR INSPECTING AN INNER WALL SURFACE OF A PIPE

(71) Applicant: Sandvik Materials Technology Deutschland GmbH, Dusseldorf (DE)

(72) Inventor: Thomas FROBÖSE, Versmold (DE)

(73) Assignee: Sandvik Materials Technology Deutschland GmbH, Düsseldorf (DE)

(21) Appl. No.: 18/111,074

(22) Filed: Feb. 17, 2023

(30) Foreign Application Priority Data
Feb. 17, 2022 (DE) 102022103820.3

(51) Int. Cl. G01N 27/90; G01N 27/9013; F16L 55/28

(52) U.S. Cl. CPC G01N 27/9006; G01N 27/902; F16L 55/28; F16L 2101/30

(57) ABSTRACT

Device for inspecting an inner wall surface of a metal tube having a linear drive, an elongated probe holder and an eddy current probe. The eddy current probe is mounted on probe holder and the probe holder is operatively connected to linear drive in such manner that probe holder is movable together with eddy current probe in an axial feed direction through tube to be tested when device is in operation.

### TECHNICAL AREA

The present disclosure relates to an device for inspecting an interior wall surface of a tube of metal, the device comprising a linear actuator, an elongated probe holder, and an eddy current probe, wherein the eddy current probe is mounted to the probe holder, and wherein the probe holder is operatively connected to the linear actuator in such manner that the probe holder is movable together with the eddy current probe in an axial feed direction through the tube to be inspected during operation of the device.

Additionally, the present disclosure relates to an device utilized in the fabrication of a tube of metal, the device comprising a device of this type for inspecting the inner wall surface of the tube.

A method of inspecting an inner wall surface of a metal tube, comprising the steps of: (A) moving an eddy current probe in an advancing direction through the tube; and (B) detecting an eddy current induced in the wall of the tube from the inner wall surface by means of the eddy current probe.

### BACKGROUND

It is known from the prior art to inspect the wall of a tube made of metal for defects using an eddy current test. However, eddy current testing in the area of the inner wall surface of a tube proves to be rather costly. The eddy current probe must be passed through the inner cross-section of the tube in order to test the tube along its entire length. Such a passage of the eddy current probe through the tube is constructively complex and time-consuming, since the eddy current probe must be pulled out of the tube again following the measurement so that the tube may be processed further. For this reason, eddy current measurements in the area of the inner wall surface of a tube are only used as spot checks and not for a 100% inspection in ongoing production.

By contrast, the present disclosure is based on the aspect of providing a device for inspecting an inner wall surface of a tube made of metal, which enables a 100% inspection of tubes in a running production.

### SUMMARY

This task is solved according to the present disclosure by means of a device according to independent claim 1 of this application. For this purpose, the device of the type mentioned above provides that an elastically deformable scraper, which surrounds the probe holder in a circumferential direction, is arranged on the probe holder in front of the eddy current probe in the feed direction for scraping off chips or other impurities from the inner wall surface of the tube.

The eddy current probe is mounted on the elongated probe holder. Using this probe holder, the eddy current probe is guided through the tube from a first end of the tube in a feed direction, so that the eddy current probe detects the induced eddy currents along the entire axial extension of the tube. After reaching the opposite second end of the tube, the probe holder is pulled out of the tube again together with the eddy current probe against the direction of advance. The elongated probe holder is connected to the linear drive in order to effect a relative movement of the eddy current probe through the tube.

In one embodiment of the disclosure, the elongated probe holder is a rod, such as a cylindrical rod or tube. In one embodiment of the disclosure, the rod or tube is made of metal.

A linear drive in the sense of the present application is a drive which effects a translatory movement of the probe holder. According to one embodiment of the present disclosure, a linear drive comprises an element selected from a screw drive, in particular a ball screw drive or a roller screw drive. In such an embodiment, the linear actuator further comprises a rotating electric motor for driving the actuator. In an alternative embodiment, the linear actuator comprises a hydraulic cylinder, a pneumatic cylinder or an electromechanical linear actuator, in particular a linear motor or a linear actuator.

An eddy current probe in the sense of the present application is a measuring device for detecting an eddy current induced in the wall of the tube, the eddy current being induced by a magnetic field generated by an excitation coil. In addition to an excitation coil, the eddy current probe therefore comprises a sensor which detects the magnetic field generated by the eddy current. The measured parameters of the magnetic field generated by the induced eddy current are the amplitude and a phase shift between the excitation signal and the alternating magnetic field measured by the sensor. In one embodiment of the disclosure, the eddy current probe comprises as a sensor a second coil, referred to as a detector coil. Alternatively, another magnetic field sensor such as a GMR sensor or a SQUID is used.

The majority of defects and damage in an electrically conductive material, especially a metal, will exhibit a different electrical conductivity or permeability as compared to the actual non-defective material. Thus, the induced eddy current, as well as the magnetic field generated by the induced eddy current in the region of a damage, defect or contamination, differs from the magnetic field detected for the intact, unchanged material of the tube.

In this application, the axial direction of advance refers to the direction in which the eddy current probe on the probe holder is moved through the tube from an inlet-side first end. After reaching the second, opposite end of the tube, the probe holder is retracted from the tube against the feed direction to separate the tube from the device for testing the tube's inner wall surface.

It is understood by an arrangement of the scraper in the feed direction in front of the eddy current probe that a section of the inner wall surface will first be swept by the scraper and then by the eddy current probe when the eddy current probe is fed in the feed direction.

This sequence has the advantage that the inner wall surface is completely cleaned before the detection of the eddy currents is completed.

The underlying idea of the present disclosure with respect to a tube is to reduce the total time required to complete the fabrication of a tube after it has been manufactured and before it is shipped from the manufacturer to a customer. In this manner, a 100% inspection of all manufactured and assembled tubes will be ensured. A scraper is provided on the probe holder in the feed direction upstream of the eddy current probe. This is used to clean the tube's inner wall surface. As both the eddy current probe as well as the scraper are mounted on the probe holder, both the measurement of the inner wall surface for defects and a cleaning of the inner wall surface can be performed in a single step, namely by moving the probe holder through the tube.

Until now, state-of-the-art technology has been used to clean the inner wall surfaces of tubes by means of felt plugs shot through the appropriate tube. This step can be omitted by means of the device according to the disclosure. Replacing the shoot-through cleaning process with a cleaning process using the device according to the disclosure has the additional advantage of avoiding errors resulting from the cleaning process itself. Stuck felt plugs lead either to the delivery of a defective tube containing the stuck plug or the assembled tubes must be subjected to a 100% visual inspection for any stuck felt plugs.

It is understood that in one embodiment, the elastically deformable wiper completely surrounds the probe holder in the circumferential direction so that the wiper will be in full contact with the inner wall surface of the tube and cleans it when the probe holder is passed through the tube. In one embodiment of the disclosure, the wiper is therefore annular, in particular circular, oval or polygonal in shape. In one embodiment of the disclosure, the wiper comprises a rubber, for example a fluor rubber, such as is commercially available particularly under the trade name Viton. In one embodiment of the disclosure, the wiper is an O-ring, whereby, in one embodiment of the disclosure, the O-ring is received in an annular groove in the probe holder.

In one embodiment of the disclosure, the linear actuator comprises a force and/or torque limiter. In case a contamination is present on the inner wall surface of the tube to be tested, which restricts the further translational path of the probe holder through the tube such that the translational movement will be blocked, the force and/or torque limitation will limit the force which the linear drive exerts on the probe holder. This prevents damage to the probe holder, the eddy current probe and the scraper. In one embodiment of the disclosure, the device additionally comprises a controller which is effectively connected to the linear drive and which is set up in such a manner that it outputs an error signal when the force or torque limitation is triggered.

In one embodiment of the disclosure, the force or torque limitation is implemented by means of a magnetic coupling, wherein the magnetic coupling is connected on the input side to a rotating electric motor of the linear drive and on the output side, for example, to a spindle of the linear drive.

In one embodiment of the disclosure, the linear actuator further comprises a position encoder for determining the axial position of the linear actuator and thus the eddy current probe. In one embodiment of the disclosure, the position encoder is a rotary encoder that detects a rotational position of a spindle of the linear actuator or a rotating electric motor of the linear actuator. In one embodiment of the disclosure, the position encoder has an axial resolution of 1/100 mm or less.

In one embodiment of the disclosure, an axial resolution of the eddy current probe is 50 mm or less. For the purposes of the present application, the axial resolution of the eddy current probe indicates that the eddy current probe determines an axial position of a defect or a contaminant with an accuracy of 50 mm or less.

The wiper must be guided through the tube in such a way that it is in contact with the inner wall surface of the tube to be tested and cleaned. For this purpose, the wiper is oversized compared to the inner diameter of the tube to be tested. This means that before the wiper is inserted into the tube to be tested, the wiper has an outer diameter that is larger than the inner diameter of the tube to be tested. Since the wiper is elastically deformable, it can still be inserted into the tube.

In order to enable an automated insertion of the probe holder with the eddy current probe and the wiper into the respective tube to be tested, the device has an inlet sleeve in one embodiment. In this context, the inlet sleeve is arranged such that the tube can be received in the device in a concentric manner with respect to the inlet sleeve and with a first end of the tube in contact with the inlet sleeve. Moreover, an inner diameter of an inner wall surface of the inlet sleeve and an outer diameter of the wiper are adapted to each other such that the wiper forms a contact surface with the inlet sleeve extending along an entire circumference of the inner wall surface of the inlet sleeve.

The inlet sleeve allows the wiper to be maintained in its compressed state even when the eddy current probe and wiper are not inserted into a tube that is being tested. Once the inlet sleeve and the tube to be tested are concentric with each other, and a first end of the tube, or more precisely an end face of the first end of the tube, are in contact with the inlet sleeve, the eddy current probe and the wiper may be easily introduced into the tube to be tested. More specifically, in one embodiment, the first end of the tube to be tested is in contact with an end face of the inlet sleeve.

According to one embodiment of the disclosure, the wiper exhibits an oversize relative to the inlet sleeve when it is not inserted into the inlet sleeve. In other words, the uncompressed wiper has an outer diameter that is larger than an inner diameter of the inlet sleeve.

It is understood that in one embodiment, the inner diameter of the inlet sleeve is equal to or approximately equal to the inner diameter of a tube to be tested using the device.

Therefore, in one embodiment, the present disclosure also relates to a combination of the device for inspecting an inner wall surface of a tube as described in embodiments thereof in the present application and a tube to be inspected, wherein the tube to be inspected is received in the device. In particular, in such a combination, the tube to be inspected is received in the device such that the tube is oriented concentrically with respect to the inlet sleeve.

In one embodiment of the disclosure, the inlet sleeve is an element comprising a hollow cylinder, such as a tube section. In one embodiment of the disclosure, the inlet sleeve comprises an inner wall portion made of a plastic material.

If the inlet sleeve has an inner wall section made of plastic, this has the advantage that no eddy current signal can be generated in it. In this way, the eddy current measurement signal of the eddy current probe may be used to distinguish whether it has already been inserted into a tube to be tested or whether it is still in the inlet sleeve.

In one embodiment of the disclosure, the device comprises a centering guide, wherein the centering guide is configured and arranged such that when the tube is fed into the device, the tube can be received in the centering guide such that the centering guide comes into contact with an exterior wall surface of the tube, thereby centering the inner wall surface of the tube and the inner wall surface of the inlet sleeve.

Such a centering guide is formed, for example, by a U-shaped arrangement with two legs and a back connecting the two legs. The tube is inserted into the U-shaped arrangement through the opening between the two legs, so that the two legs and the back guide the tube concentrically to the inlet sleeve. In one embodiment, the two legs of the U-shaped arrangement have a distance equal to or approximately equal to an outer diameter of the tube to be tested.

In one embodiment of the disclosure, the device further comprises a stop, wherein the stop is arranged such that a second end of the tube can be received in the device while in contact with the stop. In one embodiment, the inlet sleeve and the stop are movable relative to each other in and against the feed direction such that the tube to be tested can be clamped between the inlet sleeve and the outlet sleeve. Such an arrangement allows the tube to be tested to be automatically inserted into the fixture and then to be clamped between the inlet sleeve and the stop before the eddy current probe and wiper are inserted from the inlet sleeve into the tube to be tested.

In one embodiment of the disclosure, the device comprises a motor-driven feed device, wherein the feed device is configured to move the inlet sleeve and the stop relative to each other in and against the feed direction during operation of the device, and wherein the feed device comprises a sensor, whereby the sensor is configured in such manner that it will detect a measured distance between the inlet sleeve and the stop during operation of the device after the tube is clamped between the inlet sleeve and the stop.

In one embodiment of the disclosure, the infeed device comprises a linear drive for a translatory movement of at least the inlet sleeve or the outlet sleeve relative to each other, in and against the infeed direction. By moving the inlet sleeve and the stop towards each other, the tube to be tested will automatically be clamped between the inlet sleeve and the stop.

Now, if the distance between the inlet sleeve and the stop is measured in the clamped state of the tube, this distance will be essentially equal to the length of the tube. In one embodiment of the disclosure, the distance between the inlet sleeve and the stop is measured between an end face of the inlet sleeve and a stop face of the stop. In this case, the first end of the tube to be tested is brought into contact with the end face of the inlet sleeve and the second end of the tube is brought into contact with the stop face of the stop.

The distance between the inlet sleeve and the stop is a measure of the absolute length of the tube to be inspected. In principle, a number of measuring devices and measuring methods will be suitable for detecting the distance between the inlet sleeve and the stop. For example, the distance between the inlet sleeve and the stop can be measured using an optical method, such as an optical Doppler measurement or an interferometric method. In one embodiment, however, the distance between the infeed sleeve and the stop is measured using a position sensor of the infeed device. If one optionally keeps the position of the inlet sleeve or the stop unchanged and varies the position of the other element in each case, the measure of the distance may be acquired from knowing the position of one element and a measurement of the position of the other element.

For example, in one embodiment of the disclosure, the infeed device comprises a rotating electric motor and a spindle drive driven by the electric motor, which optionally causes either a translational movement of the infeed sleeve or of the stop. In this case, a rotary encoder, which detects an angular position of the shaft of the electric motor or the spindle drive and, if necessary, the number of revolutions, indicates a position of the element driven by the infeed device based on the system's knowledge. Knowing the position of the other element will be sufficient to determine the distance between the infeed sleeve and the stop and thus a measure of the absolute length of the tube to be tested.

In one embodiment of the disclosure, the stopper comprises an outlet sleeve, wherein an inner diameter of an inner wall surface of the outlet sleeve and an outer diameter of the wiper are matched such that the wiper forms an annular contact surface with the outlet sleeve, and wherein the inlet sleeve and the outlet sleeve are arranged and configured such that the tube can be received concentrically to the inlet sleeve and to the outlet sleeve and between the inlet sleeve and the outlet sleeve in the device.

It is understood that in one embodiment of the disclosure, the tube to be tested can be clamped between the inlet sleeve and the outlet sleeve. In one embodiment of the disclosure, the inlet sleeve and the outlet sleeve are brought into contact with a first end and a second end of the tube, respectively, so that the eddy current probe is movable together with the wiper from the inlet sleeve into the tube, through the tube, and from the tube into the outlet sleeve.

In one embodiment of the disclosure, the inner diameter of the outlet sleeve is equal to the inner diameter of the tubes to be measured.

In one embodiment of the disclosure, an end face of the outlet sleeve is in contact with an end face of the second end of the tube to be tested.

While the device according to the present disclosure is suitable for use with all types of tubing made of an electrically conductive material, it is particularly suitable for use in testing tubing having a length of 1000 mm or less, and more particularly tubing having a length of 400 mm or less and a length of 80 mm or less. Therefore, in one embodiment of the disclosure, the distance between the inlet sleeve and the stop is 1000 mm or less, in one embodiment it is 400 mm or less, and in another embodiment, it is 80 mm or less.

In one embodiment of the disclosure, multiple tubes may be received in succession between the inlet sleeve and the stop in the device. In particular, in one embodiment, it is possible to receive two tubes in succession between the inlet sleeve and the stop. In such an embodiment, several tubes can be tested and cleaned in one test run.

In one embodiment of the disclosure, the probe holder is oriented substantially vertically so that the feed direction is vertical as well. It is understood that the inlet sleeve and the stop must then be aligned so that their end faces and stop faces will be horizontal, respectively. In such an embodiment, gravity, which points in the feed direction, assists in stripping and discharging contaminants from the tube under test.

In one embodiment of the disclosure, the device comprises a locking device, wherein the locking device is arranged such that the locking device fixes the tube after a feeding between the inlet sleeve and the stop and before a pinching of the tube between the inlet sleeve and the stop. Such an interlock is particularly useful when the feed direction is essentially vertical, so that the tube could drop out of the device after being fed and before the inlet sleeve and stop are fed into the device in the absence of an interlock.

In one embodiment of the disclosure, such an interlock acts in conjunction with a centering guide as previously described. In one embodiment of the disclosure, the centering guide in the form of a U-shaped arrangement positions the tube in three directions perpendicular to the feed direction so that the interlock secures the tube in the fourth direction. In one embodiment of the disclosure, the interlock is a spring-loaded detent ball.

In one embodiment of the disclosure, at least the inlet sleeve or the outlet sleeve has a reference section made of an electrically conductive material with a reference structure for calibrating the eddy current probe. Such an embodiment allows the eddy current probe to be calibrated prior to testing a tube, in particular prior to testing each tube. In one embodiment of the disclosure, the reference section is a hollow cylindrical section of material made of an electrically conductive material, such as metal. In one embodiment of the disclosure, the reference section has a reference structure in the form of an engraving in a surface of the reference section.

In one embodiment of the disclosure, at least the inlet sleeve or the outlet sleeve comprises a cylindrical marking portion having an inner wall portion made of a non-electrically conductive material, the marking portion extending between the reference portion and the tube to be tested when the tube to be tested is introduced into the device. In one embodiment, the inlet sleeve or the outlet sleeve is composed of a hollow cylindrical reference section as previously described and a hollow cylindrical marking section, such as one made of plastic material. Should the eddy current probe undergo a translational movement starting from the inlet sleeve, the eddy current probe will be calibrated in the area of the reference section and the marking section containing the wall made of electrically non-conductive material will indicate that the next signals will be coming from the tube to be tested. A control or evaluation device thus clearly distinguishes between signals originating from the reference section and signals originating from the tube to be tested.

In one embodiment of the disclosure, the device further comprises a robotic feeder for automated feeding of the tube to be tested between the inlet sleeve and the stop. In one embodiment, the robotic feed comprises an automated gripper arm for gripping and moving the tube to be tested.

In one embodiment of the disclosure, the device comprises a controller. In one embodiment, a controller comprises a processor that is arranged, for example by means of software, to control the device and to analyze signals from the various sensors of the device.

In one embodiment of the disclosure, the controller is operatively connected to the eddy current probe such that the controller receives an eddy current measurement signal from the eddy current probe during operation of the device, the controller being arranged such that when the eddy current measurement signal exceeds or falls below a predetermined threshold, the controller outputs an error signal.

In one embodiment of the disclosure, the controller is operatively connected to the sensor of the infeed device such that the controller receives a distance measurement signal from the sensor during operation of the device, the distance measurement signal representing an actual measurement for the distance between the infeed sleeve and the stop, wherein the controller is arranged to compare the actual dimension for the distance between the inlet sleeve and the stop with a target dimension for the absolute length of the tube and then, if the actual dimension exceeds or falls below the target dimension, to output an error signal. In this way, tubes with a length beyond the tolerance for the nominal dimension of the absolute length of the tubes to be assembled can be sorted out.

The aforesaid task is further solved by means of a system for producing a tube of metal, which system comprises a cutting device for cutting the tube from a continuous tube, and the device for inspecting the inner wall surface of the tube as described in embodiments thereof described above.

In this type of facility for fabricating a metal tube, continuous tubes are finished and prepared for shipment to a customer. In particular, the facility according to the disclosure processes and assembles tubes which have been produced as seamless tubes by forming, in particular by cold forming.

In one embodiment of the disclosure, the continuous tube is a tube produced using cold pilger rolling or cold drawing, especially a tube made of stainless steel.

A tube of a predetermined length is cut from the endless tube in the cutting device. A cutting device within the meaning of the present disclosure is understood to be a device by means of which the continuous tube can be cut into shorter tube sections to be tested within the meaning of the present application. A cutting device is, for example, a saw, preferably an automated saw, or a cut-off bench, preferably an automated cut-off bench.

In one embodiment of the disclosure, the system for producing a tube comprises further processing stations in addition to the cutting device and the device for checking the inner wall surface of the tube. In particular, in one embodiment, the fabrication facility comprises further stations for cleaning the tube. In one embodiment of the disclosure, the system for fabricating the tube includes one or more of the following processing stations:
a means for forming a chamfer on an edge between an end surface of the tube and the inner wall surface and/or the exterior wall surface of the tube,
a cleaning device,
a wet cleaning device,
a cleaning device for cleaning the exterior wall surface of the tube,
a drying device for drying the interior wall surface, and
a drying device for drying the exterior wall surface of the tube.

In one embodiment of the disclosure, the device further comprises means for forming a chamfer on at least one end face of the tube and a chamfer inspection device for inspecting the chamfer. A chamfer, as defined in the present application, is a broken edge at the transition between an end face of the tube and the inner wall surface or the exterior wall surface of the tube. Such a chamfer is often necessary in order to be able to further process the tube at a later point in time. In particular, such a bevel helps in joining the tube to other tube sections. The chamfer is typically formed by machining, in particular by turning the tube.

In one embodiment of the disclosure, the system comprises a system controller.

In one embodiment of the disclosure, the chamfer testing device comprises at least a portion of a taper surface and a stop surface, wherein the chamfer testing device is arranged such that the portion of the taper surface is advanceable onto the stop surface and thus onto a first end surface at the first end of the tube received in the chamfer testing device. At the same time, a second end surface at the second end of the tube is in contact with the stop surface. Further, the chamfer testing device comprises a sensor, the sensor being arranged to detect a measure of a distance between the portion of the taper surface and the stop surface by means of the sensor. The system controller is operatively connected to the sensor of the infeed device of the device for testing the inner wall surface of the tube such that the system controller receives a length measurement signal from the sensor of the infeed device while operating the device. The length measurement signal represents a measure of the distance between the inlet sleeve and the stop and thus, during operation of the system, a measure of the absolute length of the tube received between the inlet sleeve and the stop. In addition, the system controller is operatively connected to the sensor of the bevel testing device such that the system controller receives a bevel measurement signal from the sensor during operation of the device, the bevel measurement signal representing the distance between the portion of the taper surface and the stop surface. The system control is set up in such manner that the system control calculates an actual measurement for a quality of the chamfer based on the length measurement signal and the chamfer measurement signal during operation of the system.

In one embodiment of the disclosure, the system controller is further configured such that, during operation of the device, the system controller compares the actual measurement for the quality of the chamfer with a target measurement for the quality of the chamfer, whereby the system controller outputs an error signal should the actual measurement fall below or exceed a predetermined threshold value for the target measurement.

The concept for the chamfer testing device in this case is that the taper surface exhibits the nominal angle at which the chamfer on the tube to be tested should be designed. When the absolute dimension for the length of the tube to be tested is known as a result of the length measurement using the device for testing the inner wall surface of the tube, there will be an expected value for the position up to which the taper surface may be fed onto the end surface of the tube and thus onto the chamfer, provided that the chamfer is correctly formed. In case the chamfer has the correct angle, but is too short or too long, the position of the taper will deviate from the expected nominal value for the position when it is fed to the face. The same applies if the chamfer is formed at the wrong angle. In this case, too, the taper surface will not reach its nominal position when it is fed onto the end face of the tube.

The aforementioned task is also solved by a method according to the independent claim directed to this end. For this purpose, the method of the type mentioned above further comprises the step of (C) scraping off chips or other impurities from the inner wall surface of the tube by means of an elastically deformable scraper arranged upstream of the eddy current probe in the direction of advance and contacting the tube circumferentially, the scraping off taking place at least in sections simultaneously with the detection of the eddy current.

Insofar as reference is made to the device or the process in the above general description and in the following detailed description of the variants and in the claims, the features described apply to both the device and the process.

### SHORT DESCRIPTION OF THE FIGURES

Further advantages, features and potential applications of the present disclosure will become apparent with reference to the following description of an embodiment and the accompanying figures. The foregoing general description and the following detailed description of embodiments will be better understood when read in conjunction with the accompanying drawings. The embodiments shown are not limited to the exact arrangements and devices shown. In the figures, like elements are designated by like reference signs.

FIG. 1 is a schematic cross-sectional view of a device for inspecting the inner wall surface of a tube in accordance with a variant of the present disclosure.

FIG. 2 is a schematic block diagram of a system for producing a tube using the device for inspecting the inner wall surface of a tube shown in FIG. 1.

FIG. 3 is a schematic cross-sectional view of the chamfer testing device of the system shown in FIG. 2.

### DETAILED DESCRIPTION

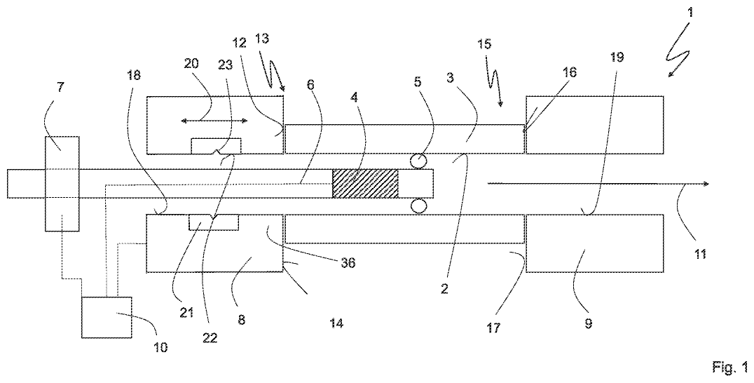

FIG. 1 is a schematic cross-sectional view of a variant of device 1 for testing an inner wall surface 2 of a tube 3. The tubes to be tested are stainless steel tubes for high pressure applications such as liquid hydrogen guidance.

Device 1 comprises an eddy current probe 4, a stripper 5, a probe holder 6, a linear drive 7, an inlet sleeve 8, an outlet sleeve 9, and a controller 10.

Probe holder 6 is elongated in the form of a tube section and extends through inlet sleeve 8 into tube 3 to be tested. Probe holder 6 serves as a carrier for eddy current probe 4 and wiper 5. Probe holder 6 can be moved automatically and motor-driven in a feed direction 11 and against feed direction 11 by means of linear drive 7 shown only schematically in FIG. 1.

During testing of the tube 3, an excitation coil in the eddy current probe 4 generates an eddy current in the electrically conductive stainless-steel material of tube 3. The induced eddy current in turn radiates an alternating magnetic field, which is detected by means of a detector coil in eddy current probe 4. In the even that the wall of tube 3 shows a defect, the electrical conductivity of the material of tube 3 changes at the position of the defect. The induced eddy current and thus the radiated magnetic field changes compared to the non-defective material of tube 3.

During an eddy current test, the control unit 10, which is connected to linear drive 7, ensures that probe holder 6 will be advanced in the direction of advance 11, and control unit 10 simultaneously receives a measurement signal from eddy current probe 4. If the eddy current measurement signal falls below a predefined threshold value, control unit 10 assumes the presence of a defect in the wall of tube 3 and emits an error signal. This error signal can, for example, be forwarded to a higherlevel system control system so that tested tube 3 will be ejected as defective from the tube producing system.

Simultaneously with the eddy current inspection by means of eddy current probe 4, inner wall surface 2 of tube 3 will be cleaned by means of scraper 5. Any impurities on inner wall surface 2 of tube 3 will be scraped off and removed from tube 3.

In one variant, device 1 is oriented vertically so that feed direction 11 points in the direction of gravity. This facilitates the conveying of impurities out of tube 3.

Wiper 5 is implemented as an O-ring made of a fluor rubber. The O-ring is accommodated in an annular groove in the probe holder. Wiper 5 is mounted on probe holder 6 upstream of eddy current probe 4 in feed direction 11. To achieve its cleaning effect, the O-ring has is oversized relative to the inner diameter of tube 3. That is, when not inserted into the tube and fully relaxed, O-ring 5 has an outer diameter which is slightly larger than the inner diameter of tubes 3 to be tested. Due to its own elasticity, the O-ring, when inside tube 3, presses against the inner wall surface 2 of tube 3. The O-ring then forms an annular contact surface with inner wall surface 2 of tube 3.

On the other hand, however, the oversize of O-ring 5 compared to the inner diameter of tube 3 makes it difficult to insert sensor holder 6 using the eddy current probe and wiper 5 into the tube. Therefore, device 1 exhibits inlet sleeve 8 and outlet sleeve 9.

These sleeves 8, 9 have the same inner diameter as tube 3. Both inlet sleeve 8 and outlet sleeve 9 have cylindrical inner wall surfaces 18, 19 inside of them. Since end face 12 of a first end 13 of tube 3 is in contact with an end face 14 of inlet sleeve 8 during the test, wiper 5 can be moved from inlet sleeve 8 into tube 3 without any interruption, starting from inlet sleeve 8. The same applies to the outlet from tube 3 to be tested at the second end 15 of tube 3, where end face 16 of tube 3 is in contact with end face 17 of outlet sleeve 9.

Tube 3 is received in the device in such a manner that inner wall surface 2 is concentric with inner wall surfaces 18, 19 of inlet sleeve 8 and outlet sleeve 9. Since inlet sleeve 8 and outlet sleeve 9 have the same inner diameter of their inner wall surfaces 18, 19 as inner wall surface 2 of the tube, inlet sleeve 8 and outlet sleeve 9 form an extension of inner wall surface 2 of tube 3.

In order to be able to clamp tube 3 between infeed sleeve 8 and outfeed sleeve 9 for the test, infeed sleeve 8 can be moved automatically in relation to outfeed sleeve 9 in and against the feed direction 11. After tube 3 has been fed between inlet sleeve 8 and outlet sleeve 9, inlet sleeve 8 is motor-driven towards outlet sleeve 9 until it clamps the tube between end faces 14, 17 of inlet sleeve 8 outlet sleeve 9.

Since the position of outlet sleeve 9 in device 1 is fixed and constant, the position of its end face 17 is also fixed. Knowing the position of end face 17, the absolute length of tube 3 being tested can be determined after determining the position of inlet sleeve 8 or its end face 14 along its feed path 20.

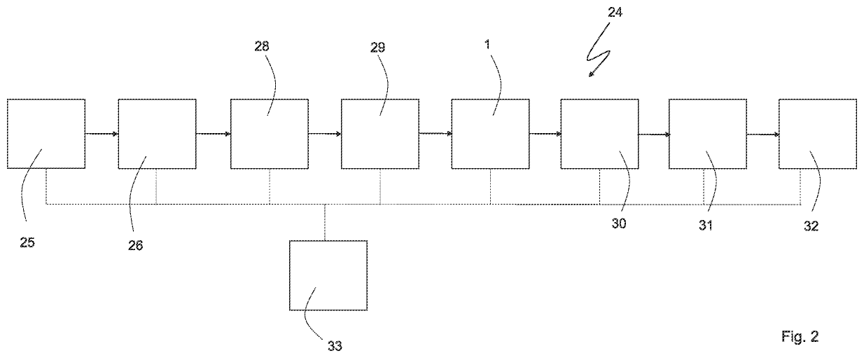

In this case, control 10 is set up in such a way that when inlet sleeve 8 has reached end face 12 of tube 3 to be tested, it determines an absolute length of tube 3 from the position of inlet sleeve 8. Control 10 outputs an error signal if the absolute length of tube 3 is outside the tolerance for the target value of the absolute length of tubes 3 to be tested. When integrated in a system for producing tubes as schematically outlined in FIG. 2, this error signal causes tested tube 3 to be rejected as defective, preferably before the actual testing with eddy current probe 4.

In the depicted variant, inlet sleeve 8 is largely made of plastic and outlet sleeve 9 is made entirely of plastic. Therefore, eddy current probe 4 does not show any characteristic signal in the area of inlet sleeve 8 and outlet sleeve 9, and the beginning and end of the test specimen in the form of tube 3 can be clearly determined from the eddy current measurement signal of eddy current probe 4.

However, inlet sleeve 8 has an annular insert as reference section 21. This reference section 21 is made of metal. Its inner wall surface 22 shows an engraving 23 as a reference structure. This engraving 23 leads not only to a change in the surface structure of ring 21, but also to a change in the microstructure, so that the eddy current measurement signal is changed in a controlled manner in the area of the engraving. Hence, engraving 23 to calibrate eddy current probe 4. Since reference section 21 is integrated into inlet sleeve 8, calibration of eddy current probe 4 can be performed before testing each tube 3.

Inlet sleeve 8 has a marking section 36 made of plastic between reference section 21 and tube 3 to be tested. If eddy current probe 4 experiences a translational movement starting from inlet sleeve 8, calibration of eddy current probe 4 occurs in the area of reference section 21, and by marking section 36 comprising the wall of electrically non-conductive material, a signal appears indicating that signals from tube 3 to be tested will follow next.

FIG. 2 illustrates in a block diagram the integration of device 1 for checking inner wall surface 2 of tube 3 of FIG. 1 into a system 24 for assembling tubes 3.

In addition to device 1 for inspecting the inner wall surface of the tube, system 24 comprises the following additional processing stations in the order listed: A cut-off bench 25 is used to cut individual tubes 3 from a provided seamless continuous tube. An end face lathe 26 is for forming a chamfer 27 on an edge between end face 12 and inner wall surface 2 of respective tube 3. In addition, system 24 has a wet cleaning device 28, an outer cleaning device 29 for cleaning the exterior wall surface of respective tube 3 before device 1 for inspecting respective tube 3, and a chamfer testing device 30, an inner drying device 31 for drying inner wall surface 2, and an outer drying device 32 for drying the exterior wall surface of the respective tube after device 1 for inspecting. The individual stations of system 24 are controlled by a system controller 33.

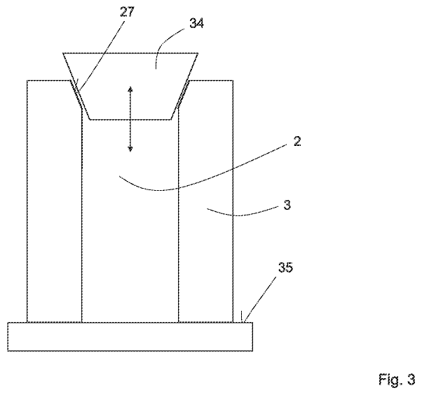

FIG. 3 schematically shows chamfer testing device 30 of system 24 of FIG. 2. Chamfer testing device 30 comprises at least a truncated cone 34 with a truncated cone surface and a stop surface 35. Truncated cone 34 can be fed onto stop surface 35 and thus onto a first end surface 12 of a tube 3 received in chamfer testing device 30. At the same time, a second end surface 16 of tube 3 is in contact with stop surface 35. Chamfer testing device 30 also has a sensor that detects distance between conic section 34 and stop surface 35. System controller 33 receives the length measurement signal from the sensor of the infeed device of device 1 to inspect the tube's inner wall surface, and a chamfer measurement signal from the sensor of chamfer inspection device 30. From the length measurement signal and the chamfer measurement signal, system controller 33 determines an actual measurement for a quality of chamfer 27.

For purposes of the original disclosure, reference is made to the fact that all features which are apparent to a person skilled in the art on the basis of the present description, the drawings and the claims, even if they have been specifically described only in conjunction with certain additional features, may be combined both individually and in any combination with other features or groups of features disclosed herein, unless this has been expressly excluded or unless technical circumstances render such combinations impossible or impractical. For the sake of brevity and readability of the description, a comprehensive, explicit presentation of all conceivable combinations of characteristics will not be provided below.

While the invention has been illustrated and described in detail in the drawings and the foregoing description, this illustration and description are merely illustrative and are not intended to limit the scope of protection as defined by the claims. The invention shall not be limited to the disclosed embodiments.

Any variations of the disclosed embodiments would be obvious to those skilled in the art based on the drawings, the description, and the appended claims. In the claims, the word “comprising” does not exclude other elements or steps, and the indefinite article “one” or “a” does not exclude a plurality. The mere fact that certain features are claimed in different claims does not preclude their combination. Reference signs in the claims are not intended to limit the scope of protection.

### REFERENCE LIST

1 Device
2 Inner wall surface of the tube
3 Tube
4 Eddy current probe
5 Scraper
6 Probe holder
7 Linear actuator
8 Inlet sleeve
9 Outlet sleeve
10 Control
11 Feed direction
12 Face of the tube
13 First end of the tube
14 Face of the inlet sleeve
15 Second end of the tube
16 Face of the tube
17 Face of the outlet sleeve
18 Inner wall surface of the inlet sleeve
19 Inner wall surface of the outlet sleeve
20 Feed route
21 Reference section
22 Interior wall surface
23 Engraving
24 Fabrication system
25 Cut-off bench
26 Face lathe
27 Chamfer
28 Wet cleaning device
29 Exterior cleaning device
30 Chamfer testing device
31 Interior drying device
32 Outdoor drying device
33 System controller
34 Truncated cone
35 Stop surface
36 Marking section

1. A device for inspecting an inner wall surface of a metal tube, comprising:
a linear drive;
an elongated probe holder; and
an eddy current probe,
wherein the eddy current probe is mounted on the probe holder,
wherein the elongated probe holder is operatively connected to the linear drive such that the elongated probe holder with the eddy current probe will be movable in an axial feed direction through the metal tube to be tested during operation of the device, and
wherein an elastically deformable scraper (5) wiper, which surrounds the probe holder in a circumferential direction, is arranged on the probe holder in front of the eddy current probe in the axial feed direction for scraping off chips or other impurities from an inner wall surface of the tube.

2. The device according to the preceding claim 1, wherein the wiper is an O-ring.

3. The device according to claim 1, wherein the device comprises at least one inlet sleeve,
wherein the inlet sleeve is arranged such that the tube is arranged concentrically with the inlet sleeve and is receivable in the device with a first end of the tube in contact with the inlet sleeve, and
wherein an inner diameter of an inner wall surface of the inlet sleeve and an outer diameter of the wiper are adapted to each other such that wiper forms a contact surface with the inlet sleeve extending along an entire circumference of the inner wall surface of the inlet sleeve.

4. The device according to claim 3, comprising a centering guide,
wherein the centering guide is designed and arranged in such manner that, when the tube is fed into the device, the tube can be received in the centering guide in such manner that the centering guide comes into contact with an exterior wall surface of the tube and thus centers the inner wall surface of the tube and the inner wall surface of the inlet sleeve.

5. The device according to claim 4, comprising a stop,
wherein the stop is arranged such that a second end of the tube will be in contact with the stop in the device, and
wherein the inlet sleeve and the stop are movable relative to each other in and against the feed direction so that the tube can be clamped between the inlet sleeve and the outlet sleeve.

6. The device according to claim 5, comprising a motor-driven infeed device,
wherein the infeed device is arranged in such a manner that, while the device is being operated, the infeed device moves the inlet sleeve and the stop relative to one another in and against the feed direction, and
wherein the infeed device comprises a sensor configured such that, while operating the device, the sensor detects a measure of a distance between the infeed sleeve and stop after the tube has been clamped between the infeed sleeve and stop.

7. The device according to claim 5, wherein the stop comprises a discharge sleeve,
wherein an inner diameter of an inner wall surface of the outlet sleeve and an outer diameter of the wiper are adapted to each other such that the wiper forms an annular contact surface with the inlet sleeve, and
wherein the inlet sleeve and the outlet sleeve are arranged and configured such that the tube is receivable in the device concentrically to the inlet sleeve and to the outlet sleeve (9) and between the inlet sleeve and the outlet sleeve.

8. The device according to claim 7, wherein the device comprises a latch, wherein the latch is arranged such that the latch fixes the tube after feeding between the inlet sleeve and the stop and before clamping the tube between the inlet sleeve and the stop.

9. The device according to claim 8, wherein at least the inlet sleeve or the outlet sleeve comprises a reference section of an electrically conductive material with a reference structure for calibrating the eddy current probe.

10. The device according to claim 9, wherein at least one of the inlet sleeve and the outlet sleeve comprises a cylindrical marking portion having an inner wall portion made of a non-conductive material, the marking portion extending, when the tube to be tested is received in the device, between the reference portion and the tube to be tested.

11. The device according to claim 1, comprising a controller,
wherein the controller is operatively connected to the eddy current probe such that the controller receives an eddy current measurement signal from the eddy current probe while operating the device, and
wherein the controller is arranged to emit an error signal when the eddy current measurement signal exceeds or drops below a predetermined threshold value.

12. An unit for assembling a tube made of metal, comprising:
a cutting device for cutting a length of tube from a continuous tube; and
the device according to claim 1.

13. A system, comprising:
the unit according to claim 12;
a device for forming a chamfer on at least one end face of the tube;
a chamfer testing device for testing the chamfer; and
a system controller,
wherein the chamfer testing device includes at least a portion of a taper surface and a stop surface,
wherein the chamfer testing device is set up in such manner that the portion of the taper surface can be advanced towards a first end face of the tube received in the chamfer testing device, while a second end face of the tube is in contact with the stop face,
wherein the chamfer testing device includes a sensor configured to measure a distance between the portion of the taper surface and the stop surface,
wherein the system controller is operatively connected to the sensor of the infeed device in such manner that during operation of the device the system controller receives a length measurement signal from the sensor of the infeed device, the length measurement signal representing a measure of the distance between the infeed sleeve and the stop and thus during operation of the system representing a measure of an absolute length of the tube received between the infeed sleeve and the stop,
wherein the system controller is operatively connected to the sensor of the chamfer testing device such that the system controller receives a chamfer measurement signal from the sensor while operating the device, the chamfer measurement signal representing the distance between the portion of the taper surface and the stop surface, and
wherein the system controller calculates an actual measurement for a quality of the chamfer based on the length measurement signal and the chamfer measurement signal while operating the device.

14. A method of inspecting an inner wall surface of a tube made of metal, comprising the steps of
moving an eddy current probe in an advancing direction through the tube;
detecting an eddy current induced in a wall of the tube from an inner wall surface by means of the eddy current probe; and
scraping chips or other impurities from the inner wall surface of the tube by means of an elastically deformable scraper arranged upstream of the eddy current probe in the advancing direction and while contacting the tube in an annular manner,
wherein the scraping occurs at least in sections simultaneously along with the detecting of the eddy current.

15. The device according claim 3, wherein at least the inlet sleeve or the outlet sleeve comprises a reference section of an electrically conductive material with a reference structure for calibrating the eddy current probe.

16. The device according to claim 15, wherein at least one of the inlet sleeve and the outlet sleeve comprises a cylindrical marking portion having an inner wall portion made of a non-conductive material, the marking portion extending, when the tube to be tested is received in the device, between the reference portion and the tube to be tested.
